(19) United States
(12) Patent Application Publication
(10) Pub. No.: US 2008/0252194 A1
(43) Pub. Date: Oct. 16, 2008

(54) ELECTRON EMITTER, FIELD EMISSION DISPLAY UNIT, COLD CATHODE FLUORESCENT TUBE, FLAT TYPE LIGHTING DEVICE, AND ELECTRON EMITTING MATERIAL

(75) Inventors: Yutaka KUROIWA, Yokohama-shi (JP); Satoru Narushima, Yokohama-shi (JP); Setsuro Ito, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 11/874,437

(22) Filed: Oct. 18, 2007

Related U.S. Application Data
(63) Continuation of application No. PCT/JP2006/308111, filed on Apr. 18, 2006.

(30) Foreign Application Priority Data
Apr. 18, 2005 (JP) 2005-119723

(51) Int. Cl. H01J 1/62; H01J 1/02; C04B 35/00

(52) U.S. Cl. 313/496; 313/309; 501/153

(57) ABSTRACT

To provide an electron emitter, a field emission display unit, a cold cathode fluorescent tube and a flat type lighting device, which employ an electron emitting material producible at a low cost and in a large amount.

A conductive mayenite type compound powder containing at least 50 mol % of a mayenite type compound represented by a chemical formula of either 12CaO.7Al₂O₃ or 12SrO.7Al₂O₃ and having a maximum particle size of at most 100 μm, is used as an electron emitter, whereby an electron emitter, a field emission display unit, a cold cathode fluorescent tube and a flat type lighting device, are realized that are easy to produce and capable of emitting electrons even at a low applied voltage and whereby a large current can be obtained per the same applied voltage surface.

### TECHNICAL FIELD

The present invention relates to an electron emitter, a field emission display unit, a cold cathode fluorescent tube, a flat type lighting device, and an electron emitting material.

### BACKGROUND ART

A field emission display unit (hereinafter referred to as FED) has a large array of micro electron sources provided with micron size electron emitters to emit electrons for every pixel, so that phosphors on positive electrodes disposed to face the micro electron sources are excited by the electron beams to glow thereby to display an image. A highly precise display is thereby possible, and it can be made to be far thinner than a CRT panel. Thus, FED is expected to be a large screen flat display. Whereas, a cold cathode fluorescent tube or a flat type lighting device uses micro electron sources provided with electron emitters which emit electrons by an intense electric field, and by reducing the tube diameter, the luminance can be made high, and at the same time, the device itself can be made small-sized and thus, it is expected to be a backlight for a non-emission display device such as a liquid crystal display device.

Typical constructions of conventional micro electron sources to be used for FED or cold cathode fluorescent tubes will be described with reference to the schematic cross-sectional views in FIGS. 4 to 6. In such a micro electron source, an emitter panel provided with an electron emitter and an anode panel provided with a positive electrode are disposed to face each other. The space between the emitter panel and the anode panel is maintained under high vacuum at a level of typically 10⁻³ to 10⁻⁵ Pa (absolute pressure, the same applies hereinafter). By applying a high voltage between the electron emitter and the positive electrode, electron beams are emitted from the electron emitter, and a phosphor formed on the positive electrode will be excited by the electron beams to glow.

The micro electron source 1 having a diode structure as shown by a schematic cross-sectional view in FIG. 4 comprises a negative electrode 4a provided with an electron emitter 2 made of a conical or needle-shaped electron emitting material, and a positive electrode 3a disposed to face the negative electrode 4a. To the electron emitter 2, a power is supplied by the negative electrode 4a. FIGS. 5 and 6 respectively show examples of conventional micro electron sources each provided with an extraction electrode 5 to apply a higher electric field to the electron emitter. FIG. 5 is a schematic cross-sectional view of a micro electron source 6 having a triode structure, and FIG. 6 is a schematic cross-sectional view of a flat type micro electron source 7 having a triode structure, wherein an extraction electrode is disposed in parallel on a glass substrate 13. In such micro electron sources, the electron emitter is made of a material such as carbon or a metal such as molybdenum (Mo).

There is a relation of the formula (1) between the electric field E and the applied voltage V at the tip of an electron emitter.

E=β×V (1)

Here, β is an electric field concentration factor. Further, there is a relation of the formula (2) between the applied voltage V and the emission current I when electrons are emitted by a high electric field (“Field Emission Display Technology”, published by CMC).

I=a×V²×exp(−b/V) (2)
a=(A×β²/Φ)×exp(9.8/Φ^{1/2})
b=(−6.5×10⁹×Φ^{3/2})/β

Here, A: emission area (m²), β: electric field concentration factor (m⁻¹), and Φ: work function (eV)

In order to facilitate driving of micro electron sources, capability of low voltage driving is desired. Particularly in an application to control emission of electrons by “on” or “off” of the driving voltage as in the case of FED, it is required to lower the driving voltage. As is evident from the formulae (1) and (2), in order to increase the emission current from an electron emitter, it is effective not only to adjust the applied voltage to be a high voltage but also to form the electron emitter by a material having a small work function, to increase the electric field concentration factor or to reduce the electrode spacing between the electron emitter and the gate electrode or positive electrode.

With carbon or a metal such as molybdenum (Mo), the work function as one of indices for emission efficiency for electrons is not so low at a level of 4 eV, whereby in order to accomplish emission of electrons at a low electric field, it was necessary to increase the electric field concentration factor by forming a fine needle-like structure. For example, in the case of molybdenum, it is used as processed into a conical shape with a height of about 1 μm. In the case of carbon, it is used as synthesized to have a linear structure with a diameter of about a few tens nm like a carbon nanotube. However, a sharp-pointed electron emitter is difficult in processing into an electrode, and if the electrode spacing is reduced, a problem is likely to result in the preparation of the element or in the reliability, whereby it has been difficult to produce electron emitters, or FED or a cold cathode fluorescent tube employing them.

On the other hand, a conductive mayenite compound exhibits a very small work function at a level of 0.6 eV, but in order to let it emit electrons, it was necessary to apply a very high voltage of at least 1.5 kV (Non-Patent Document 1).

Non-Patent Document 1: Adv. Mater. Vol. 16, p. 685-689, (2004)

### DISCLOSURE OF THE INVENTION

### Problems to be Solved by the Invention

The present invention is proposed to solve the above-mentioned problems and has an object to provide an electron emitter which can be easily prepared and is capable of emitting electrons at a low driving voltage, and a field emission display unit, a cold cathode fluorescent tube and a flat type lighting device employing such an electron emitter, and further a conductive mayenite compound powder which is useful for such as electron emitter and which can be easily prepared and is capable of emitting electrons at a low driving voltage.

### Means to Solve the Problems

The present invention provides an electron emitter comprising a substrate and a conductive mayenite type compound powder fixed on the substrate with its surface exposed, wherein the powder contains at least 50 mol % of a mayenite type compound represented by a chemical formula of either 12CaO.7Al₂O₃ or 12SrO.7Al₂O₃ and has a maximum particle size of at most 100 μm. In this case, the conductive mayenite compound powder is preferably one pulverized to have a particle size distribution such that at least 90% of the particle sizes are from 0.1 to 50 μm.

The present invention also provides a field emission display unit comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter.

The present invention further provides a cold cathode fluorescent tube comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter.

The present invention still further provides a flat type lighting device comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter.

Further, the present invention provides a conductive mayenite type compound powder for an electron emitter, which contains at least 50 mol % of a mayenite type compound represented by a chemical formula of either 12CaO.7Al₂O₃ or 12SrO.7Al₂O₃ and has a maximum particle size of at most 100 μm.

In this case, it is preferably the conductive mayenite type compound powder for an electron emitter, which has a particle size distribution such that at least 90% of the particle sizes of particles of the conductive mayenite type compound powder are from 0.1 to 50 μm. The conductive mayenite type compound powder is preferably a conductive mayenite type compound powder obtained by pulverizing a conductive mayenite type compound formed by heat treatment of its precursor, and the precursor is a carbon-containing precursor which contains carbon atoms in an amount of from 0.2 to 11.5% in a ratio of the number of carbon atoms to the total number of atoms of Ca, Sr and Al contained in the precursor.

The pulverization is preferably mechanical pulverization using no water.

### EFFECTS OF THE INVENTION

According to the present invention, it is possible to obtain an electron emission material which is easy to prepare and is capable of emitting electrons at a low driving voltage. By using this electron emitting material, it is possible to obtain an electron emitter which is easy to prepare and capable of emitting electrons even at a low applied voltage and whereby a large emission current can be obtained per the same applied voltage. Further, it is possible to realize a field emission display unit, a cold cathode fluorescent tube and a flat type lighting device, which is easy to prepare and can be driven at a low voltage.

### BRIEF DESCRIPTION OF THE DRAWINGS

FIG. 1 is a schematic cross-sectional view of a diode micro electron source of the present invention.

FIG. 2 is a schematic cross-sectional view of a triode micro electron source of the present invention.

FIG. 3 is a schematic cross-sectional view of a flat type triode micro electron source of the present invention.

FIG. 4 is a schematic cross-sectional view of a diode micro electron source of prior art.

FIG. 5 is a schematic cross-sectional view of a triode micro electron source of prior art.

FIG. 6 is a schematic cross-sectional view of a flat type triode micro electron source of prior art.

FIG. 7 is a schematic cross-sectional view of a field emission display unit of the present invention.

FIG. 8 is a schematic cross-sectional view of a cold cathode fluorescent tube of the present invention.

FIG. 9 is a schematic cross-sectional view of a flat type lighting device of the present invention.

FIG. 10 is a graph showing the characteristics of the emission current to the applied voltage, of the electron emitters of Examples 2 and 3 of the present invention.

### MEANINGS OF SYMBOLS

1: Micro electron source of diode structure of prior art
2: Electron emitter
3, 4: Substrate
3a: Positive electrode,
4a: Negative electrode
5: Extraction electrode
6: Triode micro electron source of prior art
7: Flat type triode micro electron source of prior art
8: Diode micro electron source of the present invention
9, 15, 23: Micro electron source (electron emitter) of the present invention
10: Triode micro electron source of the present invention
11: Flat type triode micro electron source of the present invention
12, 16, 24: Conductive adhesive layer
13, 21: Glass substrate
14: Transparent electrode as a negative electrode
20: Transparent electrode as a positive electrode
17: Extraction electrode
18: Insulator layer
19, 28: Phosphor layer
22: Negative electrode
25: Metal mesh positive electrode
26: Glass tube
27: Atmosphere gas comprising mercury vapor and rare gas
29: Meshed extraction electrode
30: Anode panel
40: Emitter panel
50: Spacer

### BEST MODE FOR CARRYING OUT THE INVENTION

The conductive mayenite type compound has a small work function, but has a problem that it is necessary to apply a high voltage to let it emit electrons. As a result of a study, the present inventors have found that when the conductive mayenite type compound is powdered, the powder particles exhibit multangular complex shapes and exhibit an electric field concentration factor β substantially larger than spherical bodies of the same maximum particle size. And, they have observed a phenomenon which has heretofore not been anticipated, such that when an electron emitter is formed by fixing this powder on an electrode with its surface exposed, and a voltage is applied between it and an anode disposed to face it, it is possible to attain electron emission at a low driving voltage and to obtain a large emission current.

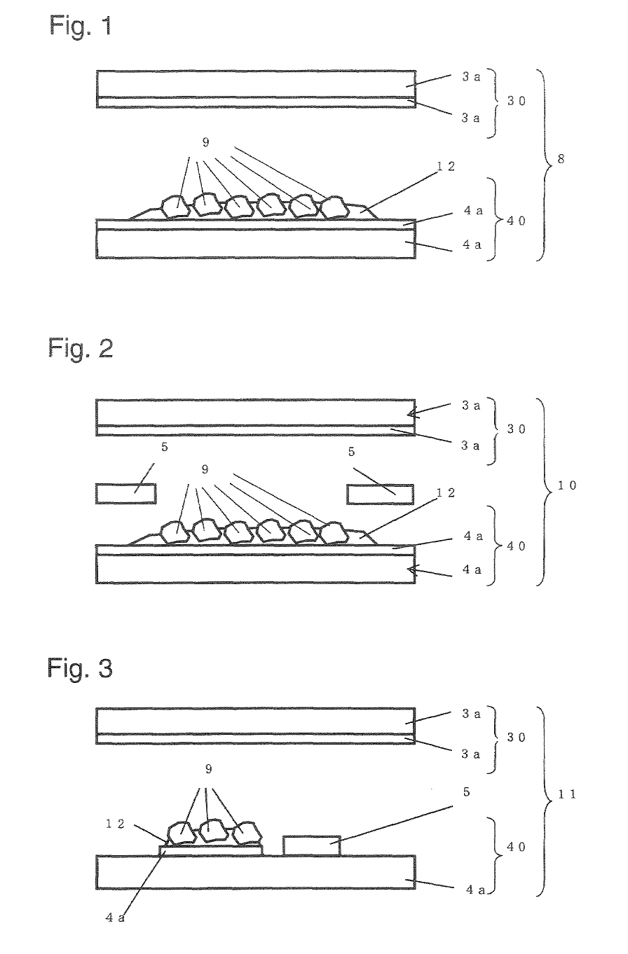

Micro electron sources employing the electron emitter of the present invention will be described with reference to the schematic cross-sectional views of FIGS. 1 to 3. FIG. 1 is a schematic view of a micro electron source 1 of diode structure employing the electron emitter 9 of the present invention, wherein an emitter panel 40 provided with electron emitters 9, and an anode panel 30 provided with a positive electrode 3a formed on a substrate 3, are disposed to face each other. In the emitter panel 40, electron emitters 9 of the present invention are fixed on a negative electrode 4a formed on the surface of a substrate 4 by a conductive adhesive layer 12, with its surface exposed, and the space between the electron emitters and the positive electrode is evacuated under vacuum of at most 10⁻³ Pa.

The micro electron source employing the electron emitter of the present invention may be made to have, other than this diode structure, a triode structure (triode micro electron source 10) as shown in FIG. 2 or a flat structure (flat type micro electron source 11) as shown by the schematic cross-sectional view in FIG. 3. The triode micro electron source 10 shown in FIG. 2 is provided with an extraction electrode 5 in addition to the diode micro electron source structure, whereby it is possible to apply a higher electric field to the electron emitters. The flat type micro electron source 11 in FIG. 3 is characterized in that the micro electron source can be formed by a production method mainly using a current film-forming technique.

### Preparation of Conductive Mayenite Type Compound Powder

The electron emitter of the present invention is made of a conductive mayenite type compound powder which contains at least 50 mol % of a mayenite type compound represented by a chemical formula of either 12CaO.7Al₂O₃ or 12SrO.7Al₂O₃ and which has a maximum particle size of at most 100 μm. If this conductive mayenite type compound powder is not a conductive mayenite type compound powder containing at least 50 mol % of a mayenite type compound represented by the chemical formula of either 12CaO.7Al₂O₃ or 12SrO.7Al₂O₃, the proportion of particles not contributing to electron emission tends to be large, whereby the desired electric current tends to be hardly obtainable. In order to let a sufficient amount of the conductive mayenite type compound be present on the exposed powder surface to carry out sufficient electron emission and conduction to a negative electrode, the content is preferably at least 70 mol %, particularly preferably at least 90 mol % in order to is obtain a sufficiently large electric current by emission of electrons.

Further, the conductive mayenite type compound powder has a maximum particle size of at most 100 μm, preferably at most 50 μm, more preferably at most 30 μm. If the maximum particle size exceeds 100 μm, the emitter may not be small-sized.

This conductive mayenite type compound powder preferably has an electric conductivity of at least 0.1 S/cm. If the electric conductivity is low, the work function tends to increase, and the voltage required for electron emission tends to be high, and when electrons are emitted, an excess Joule heat tends to be generated, and release of the adsorbed gas or deterioration of the emitter is likely to result.

The production method for the conductive mayenite type compound powder having such a high electric conductivity, is not particularly limited, but a method may for example, be mentioned wherein a mayenite type compound formed by heat treatment of a carbon-containing precursor containing carbon atoms, is pulverized. In such a case, the carbon-containing precursor preferably has a composition wherein the molar ratio or CaO or SrO to Al₂O₃ is from 11.8:7.2 to 12.2:6.8, as calculated as oxides, and the total of CaO, SrO and Al₂O₃ is at least 50 mol %, based on the carbon-containing precursor. With such a composition, it is possible to form crystals of the mayenite type compound having a good electric conductivity by the above-mentioned heat treatment.

The carbon atoms in the carbon-containing precursor are preferably contained in an amount of from 0.2 to 11.5% as a ratio of the number of carbon atoms to the total number of atoms of Ca, Sr and Al contained. With such a composition, it is possible to obtain a conductive mayenite type compound powder having a good electric conductivity by heat treatment in an atmosphere which can be easily industrially realized. Namely, such heat treatment is preferably such that the carbon-containing precursor is heated and maintained at a temperature of from 900 to 1,470° C. in a low oxygen atmosphere having an oxygen partial pressure of at most 10 Pa and then cooled at a prescribed cooling rate. By such heat treatment, the carbon-containing precursor will be crystallized and reduced to a conductive mayenite type compound. The atmosphere having an oxygen partial pressure of at most 10 Pa can easily be realized by using an industrially available high purity gas. Further, at the above heat treating temperature, the carbon-containing precursor and the conductive mayenite type compound will not melt, and the heat treatment can accordingly be carried out by a simple apparatus.

Such carbon-containing precursor is prepared preferably by melting materials prepared and mixed to obtain a desired composition of CaO, SrO, Al₂O₃ and carbon atoms, in a low oxygen atmosphere having an oxygen partial pressure of at most 10 Pa. The materials for CaO, SrO, and Al₂O₃ are not limited to oxides, and carbonates, hydroxides, etc. may optionally be employed. The amount of carbon atoms to be mixed to such materials is preferably adjusted so that the amount of carbon atoms contained in the carbon-containing precursor prepared by melting will have a desired value. As the carbon atoms to be mixed to the materials, a powder of e.g. amorphous carbon, graphite or diamond is preferably employed, but an acetylide compound, a covalently bound or ionized metal carbide or a hydrocarbon compound may also be used. Otherwise, a carbon container may be used for melting, and carbon atoms may be dissolved in a melt by the reaction with the container by melting in an atmosphere having an oxygen partial pressure of 10⁻¹⁵ Pa. If the oxygen partial pressure during the melting exceeds 10 Pa, the carbon content in the resulting carbon-containing precursor is likely to vary. The melting temperature is higher than 1,470° C., preferably at least 1,550° C.

The above heat treatment is preferably carried out against a granular precursor obtained by roughly pulverizing the above-mentioned precursor containing carbon atoms to a maximum particle size of preferably from 1 to 100 μm, whereby the reduction reaction may be facilitated by an increase of the surface area, and a high electric conductivity will be easily obtained at a low heat treating temperature. In order to easily obtain a high electric conductivity, the maximum particle size is preferably made to be 100 μm. On the other hand, if the maximum particle size is less than 1 μm, the particles are likely to agglomerate. A conductive mayenite compound thus formed contains a conductive mayenite type compound represented by either [Ca₂₄Al₂₈O₆₄]⁴⁺4e⁻ or [Sr₂₄Al₂₈O₆₄]⁴⁺4e⁻ at least as a part of the mayenite type compound represented by the chemical formula 12CaO.7Al₂O₃ or 12SrO.7Al₂O₃.

When the conductive mayenite type compound thus obtained is pulverized, it is likely to break along glassy shell-shaped or flat fracture surfaces, whereby sharp corners will be formed by the fracture surfaces and the initial material surfaces, and a powder having a shape to facilitate electron emission will be obtained. Therefore, it is preferred to pulverize the conductive mayenite type compound obtained in the above-described step to have the desired particle size distribution, whereby a conductive mayenite type compound powder for an electron emitter excellent in electron emission characteristics will be obtained. The above pulverization is preferably carried out to obtain a powder having sharp corners and at the same time not to let corners of the powder be rounded. For this purpose, it is preferred to adopt a method of mechanically pulverizing the conductive mayenite compound obtained in the above step by applying a compression, shearing and frictional force to the material by means of hammers, rollers or balls of e.g. metal or ceramics. As a pulverization apparatus for such pulverization, a stamp mill, a roller mill, a ball mill, a vibration mill, a planetary mill or a jet mill may, for example, be mentioned. Here, it is more preferred to employ a production method wherein the pulverization is carried out mechanically without using water. In a case where no water is used, an organic solvent may be used, and isopropyl alcohol or toluene may, for example, be mentioned. Among the above-mentioned pulverization methods, a jet mill wherein particles are gulfed in an air stream and pulverized by collision of particles to one another, is particularly preferred, whereby pulverization is carried out without using water, and inclusion of foreign matters will be little. In the case of a jet mill, for example, particles having a particle size of at most 1 mm are carried by an air with a flow rate of 100 L/min and introduced into a pulverization chamber, whereby a desired powder is obtainable. If necessary, such a powder may be pulverized once again by a jet mill to obtain finer particles.

The above pulverization is carried out so that the maximum particle size of the obtained conductive mayenite type compound powder will be at most 100 μm. If the maximum particle size exceeds 100 μm, small sizing of the micro electron source employing the electron emitter of the present invention tends to be difficult. It is also preferred to remove particles having particle sizes exceeding 100 μm, for example, by sieving or classifying by means of a gas stream classifier or a liquid classifier utilizing the centrifugal force or sedimentation rate. Further, the above pulverization is preferably carried out so that the pulverized powder has a particle size distribution such that the particle sizes of at least 90% of particles are preferably from 0.1 to 50 μm, particularly preferably from 0.2 to 20 μm. If particles having particle sizes of less than 0.1 μm are contained at least 10%, particles tend to agglomerate one another, whereby it tends to be difficult to produce a conductive mayenite type compound powder for an electron emitter, and when it is fixed on a negative electrode as an electron emitter, the electric field concentration effect may not adequately be obtainable. If particles having particle sizes exceeding 50 μm are contained at least 10%, the number of electron emitters disposable per unit area of the micro electron source will decrease, whereby the emission current density tends to be low, and a necessary luminance may not be obtainable.

Especially when the conductive mayenite type compound powder is used for FED, the maximum particle size of the powder is preferably at most 5 μm in order to form electron emitters within the desired region with is good productivity. In such a case, it is preferred that at least 90% of particles have particle sizes of from 0.2 to 4 μm. The conductive mayenite type compound powder constituting electron emitters is preferably such that the surface of the powder is sufficiently exposed in order to emit electrons efficiently. However, if particles of less than 2 μm are contained at least 10%, the surface of the conductive mayenite type compound powder may not sufficiently be exposed. If particles exceeding 4 μm are contained at least 10%, the number of particles of the conductive mayenite type compound powder disposable in the micro electron source tends to be small, whereby no adequate amount of electron emission tends to be obtainable.

Whereas, when the conductive mayenite type compound powder is used for a cold cathode fluorescent tube or a flat type lighting device, the maximum particle size of the powder is preferably at most 20 μm, whereby a high luminance will be readily obtained. In such a case, at least 90% of particles have particle sizes of from 0.2 to 20 μm. If particles of less than 0.2 μm are contained at least 10%, the surface of the conductive mayenite type compound powder may not be sufficiently exposed at the time of preparation of electron emitters. If particles exceeding 20 μm are contained at least 10%, the number of particles of the conductive mayenite type compound powder per unit area tends to be small, whereby no adequate amount of electron emission may be obtainable.

### Micro Electron Source

The conductive mayenite type compound powder thus obtained is excellent in electron emission characteristics, and when used as electron emitters, it can emit electrons at a low applied voltage, and a large electron emission current will be obtainable. Electron emitters employing such a conductive mayenite type compound powder can be prepared easily and at a low cost as compared with conventional electron emitters which require fine processing of carbon or a metal such as molybdenum or which employ very fine structures of a nanometer level such as carbon nanotubes.

The micro electron source employing such a conductive mayenite type compound powder as electron emitters, comprises an emitter panel provided with the electron emitters, and an anode panel, and it can be prepared as follows, using a transparent electrode-coated glass substrate. It is, of course, possible to employ other preparation methods or to change the construction, and the preparation method is not limited to the following description.

The emitter panel 40 is preferably formed by using a transparent electrode-coated glass substrate having a transparent electrode as a negative electrode (4a in FIGS. 1 to 3) formed on a glass substrate (4 in FIGS. 1 to 3). As the transparent electrode 4a, zinc oxide doped with e.g. Al or Ga, tin oxide doped with e.g. Sb or F, or an extremely thin metal film of e.g. Ag, Au or Cu may be preferably employed in addition to ITO (tin oxide-doped indium oxide) coated by sputtering. For the conductive mayenite type compound powder to be electron emitters 9, it is necessary that the particle surfaces are exposed. For this purpose, an adhesive layer 12 is applied on a transparent electrode 14, and the conductive mayenite type compound powder to be electron emitters 9 is sprayed and fixed thereon, or an adhesive having a large amount of the conductive mayenite type compound powder dispersed therein, is coated so that the powder is exposed on the surface at the time of coating. The method of coating the adhesive may, for example, be screen printing, ink jet printing or spin coating.

As such an adhesive, various types may be employed so long as it can be coated on a transparent electrode and it is capable of holding the conductive mayenite type compound powder on the transparent electrode. However, it is preferably an adhesive having an electric conductivity. Further, it is preferred that after forming the adhesive layer, the gas emission amount in vacuum is small. If the gas emission is large, the vacuum degree in a space around electron emitters will be deteriorated, and arc discharge is likely to be induced, whereby the electron emitters and their surroundings are likely to be damaged.

In the foregoing description, as the substrate for fixing the conductive mayenite type compound powder to form electron emitters, a transparent electrode-coated glass substrate is used, but an applicable substrate is not limited thereto. In a case where the electron emitter of the present invention is used as a luminescent element, and light is not taken out from the substrate for the electron emitters, it is possible to employ an electron-coated substrate made of a material which is not transparent, such as a metal, ceramics, etc.

The anode panel 30 is preferably formed by using a transparent electrode-coated glass substrate having a transparent electrode as a positive electrode (3a in FIGS. 1 to 3) formed on a glass substrate (3 in FIGS. 1 to 3). As the transparent electrode, the same transparent electrode as the transparent electrode used in the emitter panel may be employed.

In the micro electron source of the present invention, the emitter panel 40 and the anode panel 30 are disposed at a prescribed distance with the electrode surfaces facing to each other, and the space between the electron emitters 9 and the positive electrode 3a is maintained to be highly evacuated in a vacuum of from 10⁻³ to 10⁻⁵ Pa.

In the micro electron source having a diode structure of the present invention, the distance between the emitter panel 40 and the anode panel 30 is set to be is from 3 to 20 μm, and a high voltage is applied between the negative electrode 4a and the positive electrode 3a to let emitters 9 emit electrons. The applied voltage is typically a few hundreds V, and the positive electrode is set to have a higher potential. In the micro electron source having a triode structure of the present invention, three electrodes of the emitter panel 40, the anode panel 30 and the extraction electrode 5 are provided. The distance between the electron emitters 9 and the extraction electrode 5 is set to be from 3 to 20 μm, and typically, a voltage of from 10 to 100 V (the positive electrode having a higher potential) is applied for electron emission. The distance between the extraction electrode 5 and the positive electrode 3a is set to be from 0.5 to 4 mm, and typically, a high voltage of a few kV (the positive electrode having a higher potential) is applied to accelerate electrons emitted from electron emitters 9 and let them enter into the positive electrode.

At that time, if a phosphor layer made of a phosphor is formed on the positive electrode 3a, it can be excited by the above emitted electrons to glow. It is also preferred that the space between the electron emitters 9 and the positive electrode 3a is made to be, for example, a mixed gas atmosphere of mercury vapor and a rare gas with a pressure of from 10⁻¹ to 10⁻³ Pa, and mercury atoms are excited by the emitted electrons to generate ultraviolet beams, so that the phosphor layer 28 is excited by such ultraviolet beams to glow.

The substrate or electrode on the side where no emitted light is taken out, is not required to be transparent, and glass or a transparent electrode may not necessarily be employed, and another substrate or electrode may be employed.

### FED

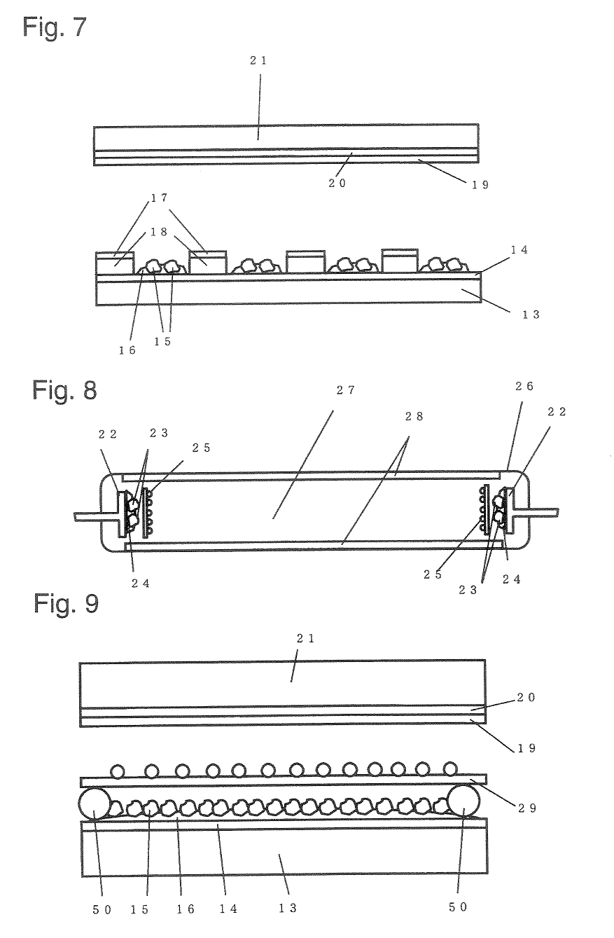

Now, a field emission display unit (FED) employing the conductive mayenite type compound powder and electron emitters of the present invention, will be described with reference to FIG. 7, but FED is by no means restricted by the following description.

FED shown in FIG. 7 has a triode structure provided with extraction electrodes 17 and comprises an emitter panel having extraction electrodes 17 and electron emitters 15 made of the conductive mayenite type compound powder, and an anode panel having a positive electrode 20 and a phosphor layer 19 formed on the positive electrode. On the emitter panel, a transparent electrode 14 connected to electron emitters 15 and extraction electrodes 17 are periodically disposed by patterning, and to each of them a voltage can be applied independently from the exterior.

To the respective electrodes of FED having such a construction, desired high voltages are applied by means of external power sources, so that electrons are emitted from the surfaces of electron emitters 15 by a high voltage (typically from 10 to 100 V, and the positive electrode having a high potential) applied between the extraction electrodes and the transparent electrode 14 of the conductive mayenite compound powder, and electrons passed through the openings of the extraction electrodes 17 are accelerated by a high voltage (typically a few kV, and the positive electrode having a higher potential) applied between the positive electrode 20 and the extraction electrodes 17 and permitted to enter into the phosphor layer 19, whereby the phosphor is excited to glow. As mentioned above, a voltage can be applied from the exterior independently to each of many micro electron sources formed on the emitter panel, the micro electron sources can be driven for every pixel to obtain a desired display.

As the substrate for the emitter panel, a glass substrate 13 having a transparent electrode 14 formed thereon is preferably employed. Electron emitters 15 are formed by applying a conductive adhesive on the surface of a transparent electrode 14 to form a conductive adhesive layer 16, then spreading the conductive mayenite type compound powder thereon and solidifying the conductive adhesive. By such a construction, the conductive mayenite type compound powder serving as electron emitters 15 is fixed on the substrate surface with the surface of the powder being exposed and electrically connected to the transparent electrode 14 on the glass substrate 13 by the conductive adhesive layer 16.

The extraction electrodes 17 are formed by forming insulator layers 18 on the transparent electrode 14 and laminating conductive layers on such insulator layers 18. As such insulator layers 18, layers of silicon dioxide or polyimide formed in a desired pattern and having a thickness of from 1 to 20 μm may, for example, be mentioned. Such insulator layers may be made to have a desired pattern by applying patterning during or after forming the above-mentioned insulator layers. The extraction electrodes 17 are formed as laminated on the insulator layers 18 and may be formed to have a desired pattern during or after forming them in the same manner as the insulator layers. Such extraction electrodes 17 may, for example, be metal films of e.g. Al or Cr deposited by sputtering, followed by patterning, or wiring patterns formed by screen printing a paste containing fine metal particles of e.g. silver or copper. The thickness is not limited so long as electric conductivity can be ensured, but it is preferably from 0.1 to 5 μm.

The opening width between the adjacent extraction electrodes 17 may be smaller than the width of one pixel, and it is typically from 5 to 100 μm, preferably from 10 to 20 μm. If it is less than 5 μm, highly precise patterning will be required, and such will be costly and undesirable. And if it exceeds 100 μm, the electric field is likely to be weak at the center portion of the opening, whereby electron emission is likely to be inadequate. In order to obtain a display with more uniform luminance within a pixel, the opening width is preferably at most 20 μm. In order to obtain adequate luminance and at the same time to facilitate the production, the opening width is preferably at least 10 μm.

The anode panel is formed by laminating a phosphor layer 19 on the transparent electrode 20 of the transparent electrode-coated glass substrate, and the transparent electrode 20 is used as a positive electrode. On the surface of the phosphor layer 19, a thin metal film of e.g. Al may be formed to prevent static charge.

The anode panel and the emitter panel are laminated and integrated by applying a vacuum seal along their periphery, so that the electrode-formed surfaces of the respective substrates will face each other, and terminals (not shown) for power feeding to the positive electrode and the patterned respective negative electrodes and extraction electrodes, are taken out, and sealed to maintain the interior in a high vacuum of from 10⁻³ to 10⁻⁵.

The distance between the electron emitters 9 and the extraction electron 5 is preferably set to be from 3 to 20 μm. If it is less than 3 μm, the production tends to be difficult, and the insulation may not be maintained. If it exceeds 20 μm, the voltage required for electron emission tends to be high, whereby an expensive driving circuit may be required, or driving is likely to be difficult.

The distance between the extraction electrodes 5 and the positive electrode 3a is preferably set to be from 0.5 to 4 mm. If it is less than 0.4 mm, arc discharge is likely to be induced between both panels, and if it exceeds 4 mm, convergence of emitted electrons tends to be low, and the display quality is likely to be low. By using electron emitters of the present invention, it is possible to produce the FED unit easily and at low costs.

### Cold Cathode Fluorescent Tube

Now, a cold cathode fluorescent tube employing the conductive mayenite type compound powder and electron emitters of the present invention will be described with reference to FIG. 8. However, the cold cathode fluorescent tube of the present invention is by no means restricted by the following description. The cold cathode fluorescent tube of FIG. 8 has a pair of electron sources of diode structure each provided with a negative electrode 22 and a positive electrode 25, in a cylindrical glass tube 26 having an inner surface coated with a fluorescent layer 28. The interior or the cold cathode tube is evacuated in a high vacuum, and then a mixed gas of mercury vapor and rare gas with a pressure of from 10⁻¹ to 10⁻³ Pa is sealed in, followed by sealing. On the surface of the negative electrode 22, electron emitters 23 made of the conductive mayenite type compound powder are fixed by a conductive adhesive layer 24 with the particle surfaces being exposed, and the positive electrode 25 is made of a lattice-like metal mesh electrode. The negative electrode 22 and the positive electrode 25 are disposed to face closely each other, and a voltage is independently applied to each of them from the exterior.

When a high voltage (typically a few hundreds V and the positive electrode having a higher potential) is applied between the positive electrode 25 and the negative electrode 22, electrons will be emitted from the surfaces of the electron emitters 23 made of the conductive mayenite type compound powder. A part of emitted electrons will be captured by the positive electrode 25, but electrons not captured and passed through the metal mesh electrode will excite mercury atoms in the atmosphere gas 27 to let them generate ultraviolet beams, and such ultraviolet beams will excite the phosphor layer 28 to let it glow. According to this method, it is possible to produce electron emitters which can be driven at a low voltage and whereby a large electron emission current is obtainable, easily and at low costs, and accordingly, a cold cathode fluorescent tube can be obtained with good productivity at low costs.

### Flat Type Lighting Device

Now, a flat type lighting device employing the conductive mayenite type compound powder and electron emitters of the present invention, will be described with reference to FIG. 9, but the flat type lighting device of the present invention is by no means restricted by the following description. In the flat type lighting device in FIG. 9, an anode panel and an emitter panel, each prepared by means of a transparent electrode-coated glass substrate, are disposed to face each other, and a micro electron source of a triode structure provided with a meshed extraction electrode 29, is used.

In the emitter panel, electron emitters 15 made of the above-described conductive mayenite type compound powder are fixed on a transparent electrode 14 as a negative electrode by a conductive adhesive layer 16, with the surface of the powder being exposed. The anode panel is prepared by laminating a phosphor layer 19 on a transparent electrode 20 to be used as a positive electrode. The phosphor layer 19 may, for example, be formed by applying a photosensitive slurry containing a phosphor and if necessary, subjected to patterning by photolithography after being formed. As the phosphor, ZnO:Zn may, for example, be employed. On the surface of the phosphor layer 19, a thin conductive film such as an Al film may be formed to prevent static charge. As the is meshed extraction electrode 29, a metal mesh obtained by weaving a metal wire made of a metal such as stainless steel, aluminum or niobium, or a perforated metal plate may, for example, be preferably employed. The thickness is preferably from 20 to 30 μm. The mesh openings are typically preferably from 20 to 100 μm, and the aperture ratio (opening area/total area) is preferably from 20 to 70%. As an example of the meshed extraction electrode, a stainless steel mesh may, for example, be mentioned which is obtained by weaving a stainless steel wire having a wire diameter of 100 μm in a lattice-shape of 150×150 μm.

The meshed extraction electrode 29 is electrically insulated from the electron emitters 15 and the positive electrode 20 and is held to maintain a prescribed distance therefrom. The meshed extraction electrode 29 and the emitter panel are preferably disposed so that the distance between the meshed surface of the extraction electrode and the tips of the electron emitters is from 20 to 500 μm. To maintain the prescribed electrode distance and to prevent short-circuiting by the contact of both electrodes, it is preferred to provide an insulating spacer 50 along the peripheral portion of the emitter panel or to disperse spherical spacers made of an insulator (not shown) over the entire area between both electrodes. With respect to the spherical spacers made of an insulator, it may, for example, be mentioned that silica spheres having a diameter of 50 μm are used as dispersed in a proportion of one sphere per 1 mm² of the electrode. Further it is more preferred that they are disposed as bonded to the electron emitter side of the meshed extraction electrode 29, whereby shielding by the extraction electrode can be minimized. Further, the meshed extraction electrode 29 and the anode panel are preferably disposed such that the distance between the meshed surface of the extraction electrode and the surface of the phosphor layer is from 0.5 to 4 mm.

The anode panel and the emitter panel are laminated and integrated by applying a vacuum seal along their periphery so that the respective electrode-formed surfaces face each other, and the interior is evacuated to a high vacuum state of from 10⁻³ to 10⁻⁵ Pa and then sealed.

The flat type lighting device of this construction is designed so that electrons emitted from the surface of the electron emitters 15 made of the conductive mayenite type compound powder by applying a voltage from an external power source (not shown) to each of the positive electrode 20, the transparent electrode 14 as a negative electrode and extraction electrodes 29, are accelerated by a voltage (typically a few kV, and the positive electrode having a higher potential) applied between the meshed extraction electrode 29 and the positive electrode 20 and permitted to enter into a phosphor layer 19 on the positive electrode 20, whereby the phosphor is excited to glow. The voltages applied between the extraction electrodes and the negative electrode and between the extraction electrodes and the positive electrode may, for example, be 70 V and 2 kV, respectively. In FIG. 9, each of the negative electrode and the positive electrode is formed over one surface, but it may be subjected to patterning, as the case requires. When it is subjected to patterning, the electron emitters may be driven as divided, whereby the degree of freedom of lightning will increase, such being desirable.

By using the electron emitters of the present invention, the production will be easy, and further, it is expected that the production cost can be reduced.

### EXAMPLES

Now, the present invention will be described in detail with reference to Examples, but it should be understood that the present invention is by no means restricted to the following Examples. Examples 1, 2, 4 and 6 are Working Examples of the present invention, and Examples 3 and 4 are Comparative Examples.

### Example 1

Firstly, in accordance with a prescribed method, to a glass material of a composition comprising 61.0 mol % of CaO, 35.3 mol % of Al₂O₃ and 3.7 mol % of SiO₂, as calculated as oxides, a carbon powder was added in an amount of 0.8% as a ratio in the number of atoms to the total number of atoms of Ca, Al and Si in this glass material, to prepare a carbon-containing calcium aluminate glass material. Then, this material was melted at 1,650° C. and vitrified to obtain a bulky carbon-containing calcium aluminate glass. The obtained glass was analyzed by Raman spectroscopy, whereby it was found that carbon was contained in the state of C₂²⁻ ions in the glass. Further, by the secondary ion analysis and the combustion analysis, the carbon atoms contained in the obtained glass were confirmed to be 0.5% as a ratio in the number of atoms to the total number of atoms of Ca, Al and Si in this glass.

This carbon-containing calcium aluminate glass was roughly pulverized to the maximum particle size of 100 μm and subjected to heat treatment by holding it in an nitrogen atmosphere of 1,300° C. for 3 hours, to obtain a conductive mayenite type compound. The obtained conductive mayenite type compound was crushed in an alumina mortar without using water to obtain a conductive mayenite type compound powder having a maximum particle size of 100 μm and having a particle size distribution such that the particle sizes of at least 90% of the powder were from 0.1 to 50 μm.

### Example 2

By using the conductive mayenite type compound powder in Example 1, a micro electron source 8 of diode structure as shown in FIG. 1, was prepared. A transparent electrode-coated glass substrate 4 having a transparent electrode of ITO formed on one side, was prepared; on the transparent electrode 4a, a conductive paste (Dotite, manufactured by Fujikura Kasei Co., Ltd.) was applied; and on the applied conductive paste, this powder was sprinkled. Then, this substrate was evacuated to a vacuum degree of at most 5×10⁻⁴ Pa to sufficiently evaporate the solvent and to solidify the conductive paste, to obtain an emitter panel 10 of this Example. By the above steps, electron emitters 9 made of the conductive mayenite type compound powder were fixed on the negative electrode 4a by a conductive adhesive layer 12 made of the solidified conductive pastes, with the surface being exposed.

Another sheet of the same transparent electrode-coated glass substrate was prepared to be used as an anode panel 3, and the emitter panel and the anode panel were disposed to face each other. At that time, the emitter panel and the anode panel were held so that the distance between the upper ends of the electron emitters 9 and the surface of the positive electrode (not shown) on the anode panel surface would be 0.3 mm and set in a vacuum container (not shown), followed by evacuation to at most 5×10⁻⁴ Pa. Using an external power source, to the diode type micro electron source thus formed, a positive voltage was applied to the positive electrode, and the negative electrode was earthed, whereby the electric current flowing between both electrodes was measured.

### Example 3

In the same manner as in Example 1, a bulky carbon-containing calcium aluminate glass was prepared. The prepared bulky glass was put in a carbon crucible and subjected to heat treatment by holding it in a nitrogen atmosphere of 1,300° C. for 3 hours, and then left to cool in the furnace to obtain a bulky conductive mayenite type compound.

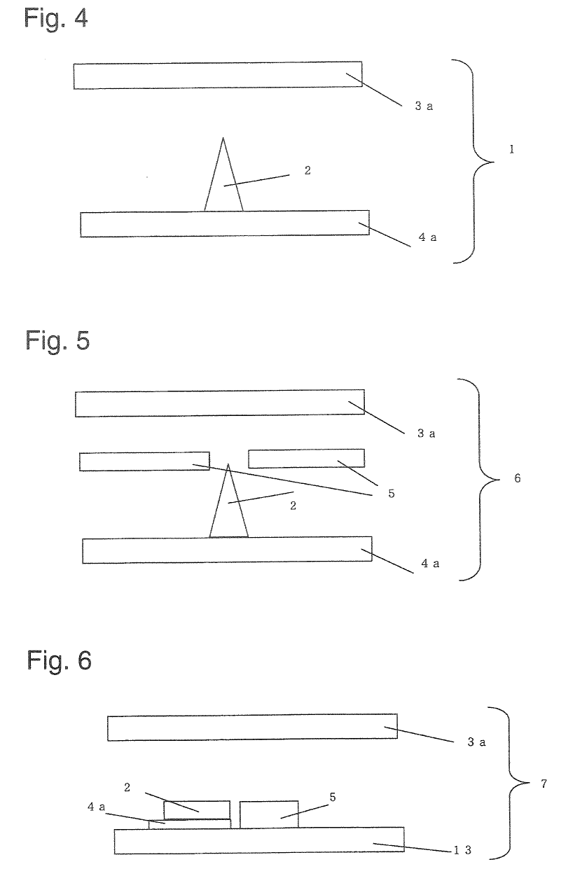

The obtained conductive mayenite type compound was crushed to have a pyramid shape, and by using it, a microelectron source 1 having the structure of FIG. 4 was prepared. Namely, a transparent electrode-coated glass substrate 4 having a transparent electrode made of ITO formed on one side, was prepared. On the transparent electrode of this transparent electrode-coated glass substrate 4, the pyramid-shaped conductive mayenite type compound was fixed so that the apex of the pyramid shape was located above, to form an electron emitter 2 of this Example. Then, the emitter panel was evacuated in a vacuum container to a vacuum degree of at most 5×10⁻⁴ Pa to sufficiently evaporate the solvent thereby to solidify the conductive paste.

In the same manner as in Example 2, an anode panel was prepared. The emitter panel and the anode panel were held so that the distance between the apex of the electron emitter 2 and the upper positive electrode would be 0.3 mm, and set in a vacuum container. The interior of the vacuum container was evacuated to at most 5×10⁻⁴ Pa to obtain a diode type micro electron source of this Example. By using an external power source in the same manner as in Example 2, to the diode type emitter thus formed, a positive voltage was applied to the positive electrode, and the negative electrode was earthed, whereby the electric current flowing between both electrodes was measured.

### Example 4

In the case of a hemisphere-formed flat panel in a uniform electric field i.e. in a case where a pair of flat plate electrodes are disposed to face each other, and the electrode surface of one of them is provided with a hemispherical projection, it is known that the electric field at the forward end of the hemispherical projection is three times the electric field in the case where no such hemispherical projection exists. When the electric field concentration factor β is calculated by setting the diameter of the hemispherical projection to be 100 μm and the distance between the forward end of the projection and the facing electrode to be 300 μm, β became 1×10⁴ m⁻¹.

### Evaluation Results of the Diode Type Micro Electron Sources in Examples 2 to 4

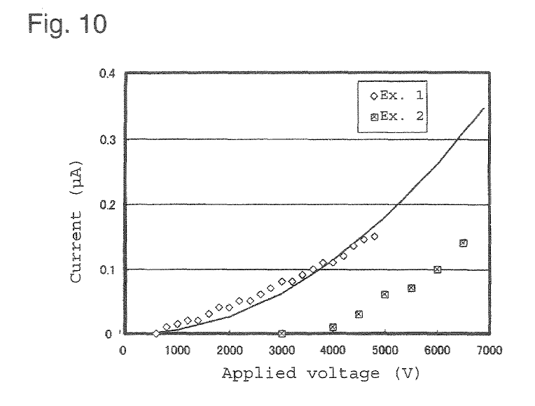

With respect to the diode type micro electron sources employing the conductive mayenite type compound is powder in Example 2 and the bulky product of conductive mayenite type compound processed into a pyramid-shape in Example 3, respectively, as electron emitters, the changes in the emission current to the applied voltage were measured, and the results are summarized in the graph in FIG. 10. From this graph, it is evident that as compared with Example 3 wherein an electron emitter of the bulky product was employed, in Example 2 wherein an electron emitter of the powder was employed, the electron emission starts at a low applied voltage, and a larger electric current is obtainable at the same applied voltage. In Examples 2 and 3, the material for the electron emitters and the electrode distances are the same, and therefore, this difference is considered to be attributable to the difference in the electric field concentration factor. Namely, it has been found that when the conductive mayenite type compound is powdered, a large electric field concentration factor suitable for use as an electron emitter can be obtained.

When the results of Examples 2 and 3 were subjected to fitting by means of the above-mentioned formula (2) showing the relation between the applied voltage V and the emission current I in the electric field electron emission, they agreed very well with the measured results. The fitting result with respect to Example 2 is shown by a solid line in the graph. When the work function is taken as 0.6 eV, and β at that time is obtained from the fitting parameter, in Example 2, the electric field concentration factor β was as large as 1×10⁷ m⁻¹. In Example 3, the electric field concentration factor β was 1.5×10⁵ m⁻¹.

Namely, with the conductive mayenite compound powder in Example 2, a large electric field concentration factor β corresponding to about 70 times to the pyramid-shaped conductive mayenite type compound bulky product in Example 3 or about 1,000 times to the hemispherical projection in Example 4, was obtained. Thus, it has been found that an unexpectedly far larger electrical field concentration effect can be obtained by the powdering.

### Example 5

In this Example, FED employing a micro electron source of triode type structure employing the micro electron source of the present invention will be prepared. Two sheets of glass substrates (PD200, manufactured by Asahi Glass Company, Limited) having a thickness of 2.8 mm and having a transparent electrode made of ITO formed by sputtering, are prepared, and by using one sheet thereof, firstly, an emitter panel will be formed.

By photolithography and etching, the transparent electrode is subjected to patterning into a stripe shape. Then, a silver paste containing a conductive mayenite type compound powder prepared in the same manner as in Example 1, is printed by screen printing to form a pattern having a thickness of 10 μm and having a desired patterned emitter shape on a patterned transparent electrode. The conductive mayenite type compound powder used here has the maximum particle size of 5 μm, and 90% of the total particles have particles sizes of from 0.5 to 2 μm. Thus, the conductive mayenite type compound powder to constitute electron emitters 15 is fixed to the substrate surface with the surface of the powder being exposed, and it is electrically connected to the transparent electrode 14 on the glass substrate by the conductive adhesive layer 16.

Extraction electrodes 17 are formed on a glass substrate to be an emitter panel. Firstly, a polyimide type photosensitive resin layer having a thickness of 15 μm is formed by screen printing, and further an aluminum film having a thickness of 0.3 μm is laminated by sputtering. By photolithography and etching, the aluminum film and the polyimide film at unnecessary portions are removed to form the insulator layers 18 and extraction electrodes 17 having desired patterns with the opening diameter of the gate electrodes being 10 μm.

Using another sheet of a transparent electrode-coated glass substrate, an anode panel will be prepared. The anode panel is prepared by applying a photosensitive slurry containing a phosphor of the transparent electrode 20 of the glass substrate 21, then repeating an operation of patterning by photolithography to form a phosphor layer 19 having a desired pattern (not shown) wherein phosphors having the respective RGB colors are arranged. The transparent electrode 20 is employed as a positive electrode. With respect to the phosphors, SrTiO₃:Pr is used for red, ZnGaO₄:Mn is used for green, and ZnGaO₄ is used for blue. On the surface of the phosphor 19, an aluminum film having a thickness of 10 nm is formed to prevent static charge. The anode panel and the emitter panel thus obtained are laminated by applying a vacuum seal around their periphery, so that the electrode surfaces of the two substrates face each other so that the distance between the upper surface of the gate electrodes on the emitter panel and the phosphor surface of the anode panel will be 3 mm. Then, the interior is evacuated in a high vacuum state of 10⁻⁴ Pa and then sealed to obtain a field emission display unit of this Example.

Using external power sources (not shown) voltages of 70 V and 3 kV are applied between the extraction electrode and the negative electrode, and between the extraction electrode and the positive electrode, respectively, whereby electrons will be emitted from the surfaces of the electron emitters 15 of the respective pixels. Electrons passed through the openings of the extraction electrodes 17 will be accelerated by the voltage applied between the extraction electrodes 17 and the positive electrode 20 and permitted to enter into the phosphor layer 19 to excite phosphors corresponding to the respective pixels to let them glow.

The field emission display unit in this Example is designed so that a voltage can be applied independently from the exterior to each of many electron emitters of the present invention made of the conductive mayenite type compound powder, whereby every pixel is independently driven to obtain a desired display.

### Example 6

An example of a flat type lighting device using the micro electron source of the present invention will be described with reference to FIG. 9.

The flat type lighting device in this Example employs a micro electron source of triode construction provided with a meshed extraction electrode 29 as an extraction electrode. As a substrate to form an emitter panel, a glass substrate (PD200, manufactured by Asahi Glass Company, Limited) having a thickness of 2.8 mm and having a transparent electrode made of ITO coated thereon, is used. Firstly, on the surface of the transparent electrode 14 to be used as the negative electrode a silver paste containing the conductive mayenite type compound powder prepared in the same manner as in Example 1 is printed by screen printing to form a pattern having a thickness of 10 μm. The conductive mayenite type compound powder used here had a maximum particle size of 10 μm, and 90% of all particles had particle sizes of from 1 to 5 μm. Then, the silver paste is dried and solidified to form an emitter panel wherein the conductive mayenite type compound powder to be electron emitters 15 is fixed to the substrate surface by a conductive adhesive layer 16 with the surface of the powder being exposed and electrically connected to the transparent electrode 14 on the glass substrate.

The anode panel is formed by using the same transparent electrode-coated glass substrate as the emitter panel and is formed by laminating a phosphor layer 19 and an antistatic layer (not shown) on a transparent electrode 20 to be used as a positive electrode. As the phosphor material, ZnO:Zn is employed. The antistatic layer is an Al film having a thickness of 10 nm.

As the meshed extraction electrode 29, a stainless steel mesh is employed which is obtained by leaving a stainless steel wire having a wire diameter of 100 μm in a lattice shape of 150 μm square. In order to prevent short circuiting of the electron emitters 15 and the meshed electrode, an insulating spacer 50 is provided along the periphery, and silica spheres having a diameter of 50 μm are disposed (not shown) in a ratio of one sphere per 1 mm² and laminated on the emitter panel. Then, the anode panel and the emitter panel are laminated and integrated by applying a vacuum seal (not shown) along the panels, so that the electrode-formed surfaces face each other, and the interior was evacuated to a high vacuum state of from 10⁻³ to 10⁻⁵ Pa and then sealed to obtain a flat type lighting device of this Example.

By using external power sources (not shown) to the flat type lighting device in this example prepared as described above, 70 V is applied between the transparent electrode 14 as a negative electrode and the extraction electrode 29, and 2 kV is applied between the positive electrode 20 and the extraction electrode 29, whereby electrons will be emitted from the surfaces of the electron emitters 15 made of the conductive mayenite type compound powder, and the electrons passed through openings of the meshed extraction electrode 29 are accelerated by the voltage between the extraction electrode 29 and the positive electrode 20 and permitted to enter into the phosphor layer 19 to excite the phosphor to let it glow.

### INDUSTRIAL APPLICABILITY

By using the electron emission material of the present invention, it is possible to obtain an electron emission material which is easy to prepare and whereby electrons can be emitted at a low applied voltage. Further, by using such an electron emission material, it is possible to easily prepare an electron emitter which is capable of emitting electrons even at a low applied voltage and whereby a large electric current is obtainable at the same applied voltage. Further, the electron emitter can be small-sized.

Further, by using the electron emission material and the electron emitter of the present invention, it is possible to realize a field emission display unit, a cold cathode fluorescent tube and a flat type lighting device, which are easy to prepare and which can be driven even at a low applied voltage. Such a field emission display unit, a cold cathode fluorescent tube and a flat type lighting device can be driven at a low voltage, whereby “on” and “off” of the driving voltage are easy, and thus they are suitable for displays.

The entire disclosure of Japanese Patent Application No. 2005-119723 filed on Apr. 18, 2005 including specification, claims, drawings and summary is incorporated herein by reference in its entirety.

What is claimed is:

1. An electron emitter comprising a substrate and a conductive mayenite type compound powder fixed on the substrate with its surface exposed, wherein the powder contains at least 50 mol % of a mayenite type compound represented by a chemical formula of either 12CaO.7Al₂O₃ or 12SrO.7Al₂O₃ and has a maximum particle size of at most 100 μm.

2. The electron emitter according to claim 1, wherein the conductive mayenite type compound powder is one pulverized to have a particle size distribution such that at least 90% of the particle sizes are from 0.1 to 50 μm.

3. A field emission display unit comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter as defined in claim 1.

4. A cold cathode fluorescent tube comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter as defined in claim 1.

5. A flat type lighting device comprising an emitter panel and an anode panel facing each other, wherein a space between the emitter panel and the anode panel is maintained to be evacuated in a vacuum higher than 10⁻³ Pa, the anode panel is provided with a transparent electrode as a positive electrode and a phosphor, a voltage is applied from an external power source between the electron emitter and the positive electrode to have electrons emitted from the electron emitter thereby to let the phosphor glow, and the emitter panel is provided with the electron emitter as defined in claim 1.

6. A conductive mayenite type compound powder for an electron emitter, which contains at least 50 mol % of a mayenite type compound represented by a chemical formula of either 12CaO.7Al₂O₃ or 12SrO.7Al₂O₃ and has a maximum particle size of at most 100 μm.

7. The conductive mayenite type compound powder for an electron emitter according to claim 6, which has a particle size distribution such that at least 90% of the particle sizes of particles of the conductive mayenite type compound powder are from 0.1 to 50 μm.

8. The conductive mayenite type compound powder for an electron emitter according to claim 6, wherein the conductive mayenite type compound powder is a conductive mayenite type compound powder obtained by pulverizing a conductive mayenite type compound formed by heat treatment of its precursor, and the precursor is a carbon-containing precursor which contains carbon atoms in an amount of from 0.2 to 11.5% in a ratio of the number of carbon atoms to the total number of atoms of Ca, Sr and Al contained in the precursor.

9. The conductive mayenite type compound powder for an electron emitter according to claim 8, wherein the pulverization is mechanical pulverization using no water.
